(19) United States
(12) Patent Application Publication
(10) Pub. No.: US 2007/0269652 A1
(43) Pub. Date: Nov. 22, 2007

(54) Optical Disk

(76) Inventor: Hiroshi Kubo, Kanagawa (JP)

Correspondence Address: TAIYO CORPORATION, 401 HOLLAND LANE, #407, ALEXANDRIA, VA, 22314, US

(21) Appl. No.: 11/662,517

(22) PCT Filed: Oct. 4, 2005
(86) PCT No.: PCT/JP05/18354

§ 371 Date: Mar. 12, 2007

(30) Foreign Application Priority Data
Oct. 5, 2004 (JP) 2004-292818
Oct. 8, 2004 (JP) 2004-295733
Nov. 25, 2004 (JP) 2004-340826

(51) Int. Cl. G11B 7/24

(52) U.S. Cl. 428/332; 428/411.1

(57) ABSTRACT

The present invention provides an optical disk that has a substrate, an information recording layer or an information-recording unit, a semi-transparent reflection layer and an image-recording layer provided in this order, and can be used for recording and playback of information by irradiating a laser from the side of the substrate. The image-recording layer can record an image by laser irradiation from the side of the substrate. The present invention also provides an optical disk that has a first lamination body and a second lamination body which are adhered to each other, wherein the first lamination body has a first substrate, one of an information recording layer and an information-recording unit, and a first reflection layer which are sequentially provided in this order, the second lamination body has a second substrate, an image-recording layer and a second reflection layer which are sequentially provided in this order, the first lamination body and the second lamination body are adhered to each other so that the side of the first reflection layer and the side of the second reflection layer face each other via an adhesive layer, the image-recording layer can record a visible image by irradiation of a laser light. The disc can record a visible image with laser irradiation. At least one of the first reflection layer and the second reflection layer is a semi-transparent reflection layer, or grooves are provided on the first substrate, or grooves are provided on the first substrate and the second substrate.

### TECHNICAL FIELD

The present invention relates to an optical disk, and specifically relates to an optical disk having an image-recording layer that allows recording of a visible image.

### RELATED ART

Optical recording media (optical disks) where information is recorded only once by laser beam irradiation are conventionally known. Such optical disks, often called recordable CD's (so-called CD-R), have a typical structure wherein a recording layer containing an organic dye, a light-reflectance layer of a metal such as gold, and a resin protective layer are formed on a transparent disk-shaped substrate in that order. Information is recorded on a CD-R by irradiation of a laser beam in the near-infrared region onto the CD-R (normally, laser beam at a wavelength of around 780 nm). In the irradiated area of the recording layer light is absorbed, there is a resulting localized increase in temperature, and this changes its physical and chemical properties (e.g., pit generation). Because of these physical and chemical changes the optical properties are changed and information can be recorded. Reading of the information (reproduction) is also carried out by irradiating with a laser beam having a wavelength the same as that of the recording laser beam. Information is reproduced by detecting the difference in reflectance between areas where the optical properties of the recording layer have been changed (recorded area) and areas where they are not changed (unrecorded area).

Recently, there is an increasing need for optical recording media higher in recording density. To satisfy this need, an optical disk called a Digital Versatile Disc (so-called DVD-R) has been proposed. The DVD-R has a structure wherein two discs, each consisting of a recording layer containing a dye, normally a light-reflection layer over each recording layer, and also a protective layer as needed, are formed on transparent disk-shaped substrates. On the disk-shaped substrates there are guiding grooves (pregrooves) for tracking an irradiation laser beam, formed of a narrow width (such as 0.74 to 0.8 μm) to be half or less than when compared to pitches (track pitches) of a CD-R. These two disks are laminated together, with an adhesive, on the recording layer side. Alternatively two disks of the above construction can be laminated together with a disc shaped protective layer laminated between them on the recording layer side. Recording and reproduction of information on and from the DVD-R are carried out by irradiation of a visible laser beam (normally, a laser beam having a wavelength in the range of 630 to 680 nm), and the recording density of a DVD-R can be made higher than that of a CD-R.

Recently, an even greater increase in the quantity of image information is expected due to the initiation of digital high-vision broadcasting, and this has been accompanied by a demand for high-capacity, high data transferring speed in recording media as well. It is said that when trying to record a digital high-vision broadcast at home, the capacity with the above-described DVD-R is already insufficient so the next generation of DVDs are also being developed. Examples of known DVDs include the HD DVD and the blue-ray discs that can record and playback two hours worth of BS digital high-vision broadcasting.

There are some known optical disks whereon a label is adhered onto the surface opposite to the recording surface. Such a label carries printed visible image information such as the song title of the audio data recorded on the recording surface, and other titles for identifying the recorded data, and the like. Such optical disks are prepared by printing the titles and the like on a circular label sheet by using, for example, a printer, and then affixing the label on the surface opposite to the recording surface of the optical disk.

However, as described above, preparation of an optical disk carrying a label, on which desired visible images such as title are recorded, demands a printer in addition to an optical disk drive. Accordingly, it requires the cumbersome procedure of recording information on the recording surface of an optical disk in an optical disk drive, then removing the optical disk from the optical disk drive, and affixing a label printed by a separate printer. Further, with the method of sticking label sheets onto the disc problems of durability such as with the adhesive can occur, so the label can peel off during use, or unbalancing of the optical disk during rotation can increase due to deviating from the center when applying. As a result, there are cases where recording and playback become impossible.

Here, proposals for an optical recording medium have been made where the medium can use a laser marker on the surface on the side opposite to that of the recording side, and the contrast between the surface and the background can be changed and displayed (see, for example, Japanese Patent Application Laid-Open (JP-A) No. 11-66617). By employing this method, desired image recording can be performed with the optical disk drive on the label surface of the optical disk without providing a separate printer and the like. With this method, however, the sensitivity is low and a high-power gas laser such as a carbon dioxide gas laser must be used. Also, visible images formed with these types of lasers exhibit low contrast so the visibility is thus inferior. Further, when an image is formed on the label surface after recording data, operation becomes complicated because it is necessary to remove the disc once, flip it over, and then insert it into the recorder.

Further, as another example, on areas that can be seen from the label side optical disks have been proposed having a changeable visible light characteristic layer of which the visible light characteristics can be changed by f irradiation of a laser from the label surface side (see, for example, JP-A No. 2002-203321). This kind of optical disk is beneficial in that visible images can be formed with the irradiation of low-output lasers.

Other examples include proposals for optical recording media that have a color-forming layer that forms a different color when lasers of different properties are irradiated thereon (see, for example, JP-A No. 2003-272240). However, these optical recording media have been problematic in that formation of laminar structures and the recording devices used are complicated, and further, fine gradation scales cannot be achieved.

Such optical disks having an image-recording layer on the label face are produced, for example, by adhering a protective layer of a first lamination body, containing at least an information-recording layer and a reflection layer formed on a substrate, to a protective layer of a second lamination body, containing at least an image-recording layer and a reflection layer formed on another substrate, via an adhesive layer. If an ultraviolet ray-curing resin is used as an adhesive for bonding the films, generally it is not possible to harden the ultraviolet ray-curing adhesive sufficiently, because each of the laminated bodies has a reflection layer and most of the ultraviolet ray, whichever direction it is irradiated from, does not reach the ultraviolet ray-curing resin as it is blocked by a reflection layer. Use of a slow curing ultraviolet ray-curing resin for adhesion, similarly to the methods for preparation of conventional double-faced DVD-R's, could be considered if optical disks of such embodiment are being formed. However, the slow curing ultraviolet ray-curing resin is generally coated by screen printing, which may cause generations of air bubbles in the resulting coated film. If these bubbles come in direct contact with the information recording layer or the image-recording layer on the opposite side, the recording, playback and saving qualities are adversely affected. In order to prevent this, an ultraviolet hardening-type protective film is necessary on the surfaces to be stuck together, thus increasing costs.

| | |
|---|---|
| Patent Document 1: | JP-A No. 11-66617 |
| Patent Document 2: | JP-A No. 2003-272240 |
| Patent Document 3: | JP-A No. 2004-103180 |
| Patent Document 4: | JP-A No. 2002-203321 |
| Patent Document 5: | JP-A No. 2000-113516 |
| Patent Document 6: | JP-A No. 2001-283464 |
| Patent Document 7: | JP-A No. 2000-173096 |

### DISCLOSURE OF THE INVENTION

Problem to be Solved with the Invention

The present invention has been accomplished in consideration of the above conventional problems. That is, the present invention provides an optical disk where a visible image can be recorded with high contrast and good efficiency with the use of a laser.

One of the embodiments of the present invention provides an optical disk where a radical polymerizable radiation cured adhesive can be used in the adhesive layer. The disc of the present invention can be manufactured at low cost.

In yet another embodiment of the present invention, an optical disk is provided with good manufacturing qualities. The disc exhibits excellent formation of visible images and visibility thereof.

Means of Solving the Problem

Specifically, the first embodiment of the present invention provides an optical disk comprising a substrate, one of an information recording layer or an information-recording portion, a reflection layer, and an image-recording layer, which are sequentially provided in this order, wherein:

a laser irradiated from the side of the substrate performs recording and playback of information;

an image is recordable in the image-recording layer by irradiation of a laser from the side of the substrate; and

the reflection layer is semi-transparent.

It is preferable that a transparent intermediate layer resides between the reflection layer and the image-recording layer.

Further, it is preferable that the reflection layer has a transmittance of 10% or higher for a laser having a wavelength of 390 nm or less and a transmittance of 70% or less for a laser having a wavelength of 405 nm, 660 nm or 780 nm.

Further, the second embodiment of the present invention provides an optical disk comprising a first lamination body and a second lamination body which are adhered to each other, wherein:

the first lamination body comprises a first substrate, one of an information recording layer or an information-recording portion, and a first reflection layer which are sequentially provided in this order;

the second lamination body comprises a second substrate, an image-recording layer and a second reflection layer which are sequentially provided in this order;

the first lamination body and the second lamination body are adhered to each other so that the side of the first reflection layer and the side of the second reflection layer face each other via an adhesive layer;

the image-recording layer can record a visible image by irradiation of a laser light; and

at least one of the first reflection layer or the second reflection layer is a semi-transparent reflection layer.

It is preferable that an adhesive in the adhesive layer comprises a radical polymerizable radiation cured adhesive.

Further, the third embodiment of the present invention provides an optical disk comprising a first lamination body and a second lamination body which are adhered to each other, wherein:

the first lamination body comprises a first substrate, one of an information recording layer or an information-recording portion, and a first reflection layer which are sequentially provided in this order;

the second lamination body comprises a second substrate, an image-recording layer and a second reflection layer which are sequentially provided in this order;

the first lamination body and the second lamination body are adhered to each other so that the side of the first reflection layer and the side of the second reflection layer face each other via an adhesive layer;

the image-recording layer can record a visible image by irradiation of a laser light;

each of the thicknesses of the first reflection layer and the second reflection layer is within the range of 15 to 200 nm;

the image-recording layer comprises a dye;

the image-recording layer satisfies the following conditions (1) to (3); and

the image-recording layer satisfies the following conditions (4) to (6) or satisfies the following condition (7), wherein, in a case where the image-recording layer satisfies the following conditions (4) to (6), grooves are provided on the second substrate, and in a case where the image-recording layer satisfies the following condition (7), an average height of depression to protrusion (Rc) of the second substrate is 10 nm or less;
(1) the refraction rate thereof for the laser light having a wavelength of 660 nm is in a range of 1.7 to 2.5;
(2) the extinction coefficient thereof for the laser light having a wavelength of 660 nm is in a range of 0.03 to 0.2;
(3) the temperature where decomposition thereof starts is in a range of 150 to 350° C.;
(4) the thickness of a land portion thereof is in a range of 10 and 200 nm;
(5) the thickness of the groove portion is in a range of 50 to 300 nm;
(6) the thickness of the groove portion is greater than that of the land portion;
(7) the thickness thereof is in a range of 30 to 300 nm, and the thickness of the image recording layer in the image-recording area is in a range of ±30% with respect to an average value of the thickness of the image recording layer.

### EFFECTS OF THE INVENTION

The optical disk of the present invention has the following merits. Namely, the present invention provides an optical disk where a visible image can be recorded with high contrast and good efficiency with the use of a laser. A radical polymerizable radiation cured adhesive can be used in the adhesive layer. The disc of the present invention can be manufactured at low cost. The optical disk is provided with good manufacturing qualities. Further, the optical disc exhibits excellent formation of visible images and visibility thereof.

### BRIEF DESCRIPTION OF THE DRAWINGS

FIG. 1 is a pattern diagram showing an example of the layer structure of the optical disk of the first embodiment of the present invention;

FIG. 2 is a pattern diagram showing another example of the layer structure of the optical disk of the first embodiment of the present invention;

FIG. 3 is a pattern diagram showing another example of the layer structure of the optical disk of the first embodiment of the present invention;

FIG. 4 is a partial cross-sectional diagram showing the layer structure of the optical disk of the second embodiment of the present invention;

FIG. 5A is an outline cross-sectional diagram showing a structural example of an embodiment where grooves are formed on the second substrate in the optical disk of the third embodiment of the present invention; and

FIG. 5B is an outline cross-sectional diagram showing a structural example of an embodiment where grooves are not formed on the second substrate in the optical disk of the third embodiment of the present invention.

### BEST MODE FOR PRACTICING THE INVENTION

Hereafter, the optical disk of the present invention will be explained.

The optical disk of the present invention can be either a recordable or rewritable disc having a recording layer where information can be recorded and played back with a laser, or a playback-only disc (for readout use) having an information-recording section (i.e., recording pits) where recorded information can be played back with a laser.

Further, the information recording format is not particularly limited and may be phase-transition recording, dye-assisted recording or write once read many format.

DVD-type configurations are included in the typical examples of the configurations of the optical disk of the present invention (including, besides DVD, DVD-R, DVD-RW, HD DVD, and the like). That is, the disc can be a type where two discs are stuck together, with a configuration where an information recording layer, image-recording layer and protective layer are formed on a substrate in this order (first embodiment); or a type where two discs are stuck together, with a configuration having at least a information recording layer on a first substrate and an image-recording layer on a second substrate (second and third embodiments).

The optical disk of the first embodiment of the present invention can have a CD-type configuration (including CD as well as CD-R, CD-RW, and the like). Possible configurations include one where an information-recording portion or information recording layer and an image-recording layer and transparent layer (i.e., a protective layer or cover layer) are formed on a substrate in this order.

Further, the optical disk of the first embodiment of the present invention can have a blue-ray disc (BD) configuration.

Examples of the optical disk of the first embodiment of the present invention are shown in the pattern diagrams and cross-sectional diagrams of FIGS. 1-3. It should be noted that the diagrams include magnified representations to facilitate understanding of the invention. An optical disk 100 has a substrate 10 on which a information recording layer 20 and a reflection layer 30 (semi-transparent reflection layer) are formed, and a protective substrate 50 on which an image-recording layer 60 and protective layer 40 are formed, stuck together via an adhesive layer 80 such that the reflection layer 30 and protective layer 40 are in the inner side. In the case where the optical disk 100 records optical information or when recorded information is played back, a laser of a preset wavelength is irradiated from the substrate 10 side (in the case of a DVD type, 650-670 nm, in the case of a HD-DVD type, 400-410 nm or less).

The image-recording layer 60 is also formed in the optical disk 100. The reflection layer 30 is semi-transparent so it can allow a laser of preset luminosity to transmit through. For this reason, when a laser is irradiated to the image-recording layer 60 from the substrate 10 side, the irradiated portions can be altered and the contrast changed, and thereby a visible image can be formed. In this manner, an image can be formed with a laser so recording of the desired image on the label surface of the optical disk (i.e., on the image-recording surface) can be performed with good efficiency using an optical disk drive, without having to provide separate components such as a printer.

It should be noted that the layer structure of FIG. 1 is only an example. The layer structure does not have to be set in the above-described order and portions thereof can be interchanged, and other known layers can be provided as well. Further, each layer can have a single-layer configuration or a multiple-layer configuration.

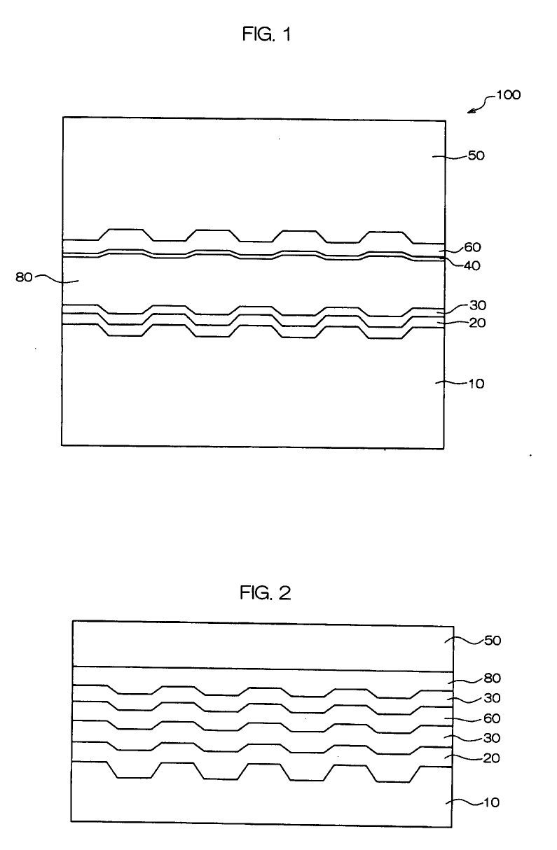

For example, as shown in FIG. 2 with the portions that correspond to the portions in FIG. 1 given the same numbers, the substrate 10 on which the information recording layer 20, reflection layer 30, image-recording layer 60 and protective layer 40 are formed and the protective substrate 50 can be configured to be stuck together via the adhesive layer 80 so that the protective layer 40 becomes an inner layer. In the case of having such a configuration, it is preferable to select a material for the reflective material whose extinction coefficient is relatively small and has a transmittance of 30% or more, even when the thickness is made between 10 and 100μm. By configuring the device in this manner, interference between information recording and image recording can be avoided.

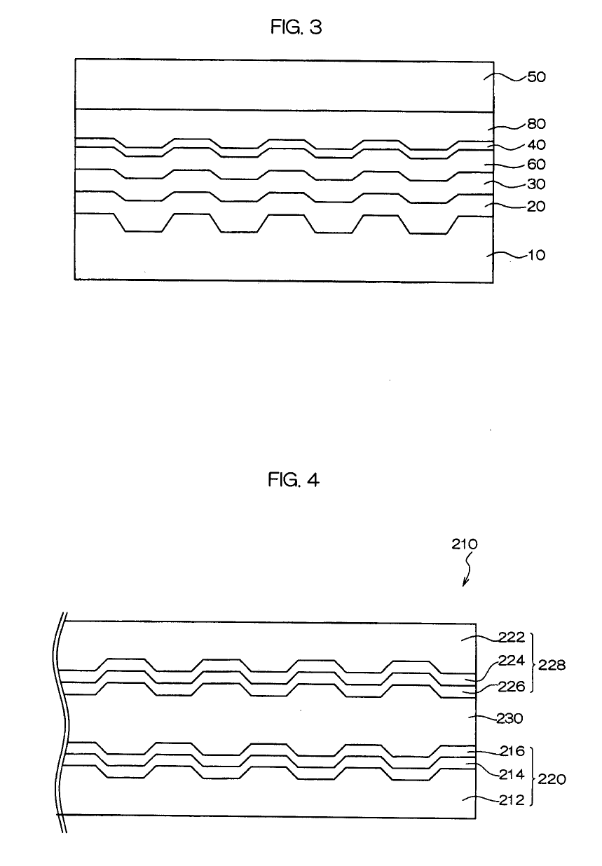

Further, the protective layer 40 can be made as a semi-transparent reflection layer in the configuration shown in FIG. 2. In other words, as shown in FIG. 3 with the portions corresponding to the portions in FIG. 2 given the same numbers, this can be configured such that the image-recording layer 60 is sandwiched with reflection layers 30. By configuring the device in this manner, focusing at the time of drawing (i.e., recording of an image) can be simplified. Also, uniform visibility from the label surface side (the image-recording layer side) can be maintained.

FIG. 4 is a partial cross-sectional diagram showing the layer structure of an optical disk 210 of the second embodiment of the present invention. The optical disk 210 has a first lamination body 220 having a information recording layer 214 and a reflection layer 216 (first reflection layer) in this order on a first substrate 212; and a second lamination body 228 having a image-recording layer 224 in which a visible image can be recorded by irradiation of a laser and a semi-transparent reflection layer 226 that allows radiation rays to transmit through (second reflection layer) in this order on a second substrate 222. The reflection layer 216 side of the first lamination body 220 and the semi-transparent reflection layer 226 side of the second lamination body 228 are stuck to each other via an adhesive layer 230 such that they face each other.

As shown in FIG. 4, the optical disk 210 of the second embodiment of the present invention has the semi-transparent reflection layer 226 through which radiation waves transmit provided in place of the reflection layer or the second lamination body 228, that is, in place of the reflection layer that should be provided at the image-recording layer 224 side. Unlike a conventional DVD-R, a reflection layer that reflects everything at the image-recording layer side does not exist. A radical polymerizable resin that is radiation cured can be used and the first lamination body 220 and second lamination body 228 can be stuck together by irradiating radiation rays from second substrate 222 side. By providing a semi-transparent reflection layer in the second lamination body, or put differently, by making the reflection layer of the image-recording layer side a semi-transparent reflection layer, it must be noted that there is degradation in the degree of reflection. Nonetheless, it is not necessary for the reflection layer of the image-recording layer side, when compared to the reflection layer of the information-recording side, to meet strict conditions so costs can be reduced without causing problems in terms of performance.

In the above configuration of FIG. 4, the second reflection layer of the second lamination body was formed as a semi-transparent reflection layer, however, the present invention is not thus limited. The reflection layer of the first lamination body can be made to be the semi-transparent reflection layer in place of the second reflection layer. In this case, when the first lamination body and the second lamination body are stuck together, this can be done by irradiating radiation rays from the second lamination body side.

Alternatively, the reflection layers of both the first lamination body and the second lamination body can be made into semi-transparent reflection layers. In this case, irradiation of the radiation rays when sticking the first lamination body and the second lamination body together can be performed from either the first lamination body side or the second lamination body side.

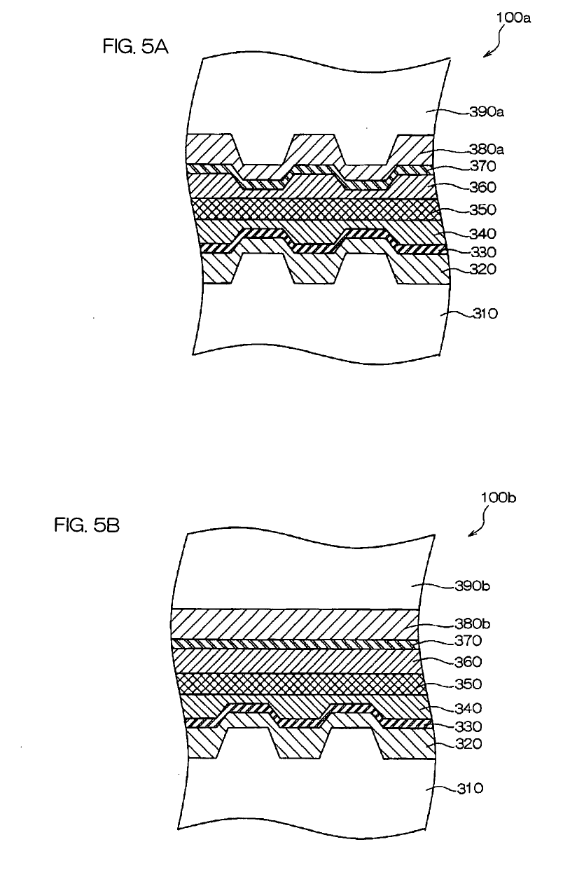

FIG. 5 are outline cross-sectional diagrams showing structural examples of an optical disk of the third embodiment of the present invention.

As shown in FIG. 5A, a first optical disk 100a of the third embodiment of the present invention has a configuration where a first lamination body has a information recording layer 320, a first reflection layer 330 and a first protective layer 340 in this order on a first substrate 310 in which grooves are provided; and a second lamination body having an image-recording layer 380a, a second reflection layer 370 and a second protective layer 360 in this order on a second substrate 390a in which grooves are provided, and these bodies are stuck together with an adhesive layer 350 such that both reflection layers 330 and 370 face each other.

Further, as shown in FIG. 5B, a second optical disk 100b of the third embodiment of the present invention has a configuration where a first lamination body has the information recording layer 320, first reflection layer 330 and first protective layer 340 in this order on the first substrate 310 in which grooves are provided; and a second lamination body that has an image-recording layer 380b, the second reflection layer 370 and the second protective layer 360 in this order on a second substrate 390b where the average height of depression to protrusion (Rc) is 10 nm or less, and these bodies are stuck together with the adhesive layer 350 such that both reflection layers 330 and 370 face each other.

In this manner, there is a mode of the optical disk of the third embodiment of the present invention where grooves are provided on the second substrate 390a, and a mode where the average height of depression to protrusion (Rc) of the second substrate 390b is 10 nm or less, i.e., there is a mode where grooves are not formed.

Hereafter, the substrate and each layer will be explained.

Information Recording Layer

The information recording layer, a layer wherein coded information such as digital information is recorded. While it is not particularly limited, and examples thereof include dye-containing, recordable, phase-transition, photomagnetic, and other layers, the recording layer is preferably a dye-containing layer.

Specific examples of the dyes contained in the dye-containing information recording layer include cyanine dyes, oxonol dyes, metallic complex dyes, azo dyes and phthalocyanine dyes.

Specific examples of the dyes further include the dyes described in JP-A Nos. 4-74690, 8-127174, 11-53758, 11-334204, 11-334205, 11-334206, 11-334207, 2000-43423, 2000-108513, 2000-158818 and others.

Furthermore, the recording substance is not limited to dyes. Preferable examples of the recording substance further include organic compounds such as: triazole compounds, triazine compounds, cyanine compounds, merocyanine compounds, aminobutadiene compounds, phthalocyanine compounds, cinnamic acid compounds, viologen compounds, azo compounds, oxonol benzoxazole compounds, and benzotriazole compounds. Amongst these compounds, cyanine compounds, aminobutadiene compounds, benzotriazole compounds and phthalocyanine compounds are particularly preferable.

While the recording layer can be formed, for example, by vapor deposition, sputtering, CVD, or solvent application, it is preferable that solvent application is utilized.

When using a solvent application, the information recording layer is formed by taking the recording substance of the dye and the like and dissolving it with a suitable solvent and with a binder, adjusting the coating liquid and next coating the solution on the substrate and forming a coating film, after which the solution is dried. The concentration of the recording substance in the coating liquid is generally in the range of 0.01 to 15% by mass, preferably in the range of 0.1 to 10% by mass, more preferably in the range of 0.5 to 5% by mass and most preferably in the range of 0.5 to 3% by mass.

Examples of solvents for the coating liquid include: esters such as butyl acetate, ethyl lactate or cellosolve acetate; ketones such as methylethylketone, cyclohexanone or methylisobutylketone; chlorinated hydrocarbons such as dichloromethane, 1,2-dichloroethane, or chloroform; amides such as dimethylformamide; hydrocarbons such as methylcyclohexane; ethers such as dibutylether, diethylether, tetrahydrofuran, or dioxane; alcohols such as ethanol, n-propanol, iso-propanol, n-butanol, or diacetone alcohol; fluorochemical solvents such as 2,2,3,3-tetrafluoropropanol; and glycol ethers such as ethylene glycol monomethylether, ethylene glycol monoethylether, or propylene glycol monomethylether.

With consideration to the solubility of dyes used, the solvents above may be used alone or in combinations of two or more. The coating liquid may further contain various additives such as antioxidants, UV absorbents, plasticizers, or lubricants according to the intended use.

When a binder is used in the invention, examples thereof include: natural organic polymers such as gelatin, cellulose derivatives, dextran, rosins or rubbers; and synthetic organic polymers, including hydrocarbon resins such as polyethylene, polypropylene, polystyrene, or polyisobutylene, vinyl resins such as polyvinyl chloride, polyvinylidene chloride, or polyvinyl chloride-polyvinyl acetate copolymers, acrylic resins such as polymethyl acrylate or polymethyl methacrylate, and initial condensates of thermosetting resins such as polyvinyl alcohol, chlorinated polyethylene, epoxy resin, butylal resin, rubber derivatives, or phenol-formaldehyde resin. Here, reference to “derivatives” means chemical compounds which can be arrived at by structural changes to small portions (e.g., to hydrogen atoms, specific atom groups, and the like) of the main compound.

When a binder is additionally used as the material for the information recording layer, the amount of the binder used is generally in the range of 0.01 to 50 times and preferably 0.1 to 5 times the weight of the dye contained in the information recording layer.

Examples of the methods of application of the coating liquid for forming the information recording layer include a spraying method, a spin coating method, a dipping method, a roll coating method, a blade coating method, a doctor roll coating method, and a screen-printing method. The recording layer may have a configuration formed of either a single layer or multiple layers. The thickness of the recording layer is generally in the range of 10 to 500 nm, preferably in the range of 15 to 300 nm, and more preferably in the range of 20 to 150 nm.

The information recording layer may contain various discoloration inhibitors for improvement of the light fastness of the information recording layer. Commonly, a singlet-oxygen quencher is used as the discoloration inhibitor. Any known singlet oxygen quencher described in literature, including patent specifications, may be used. Specific examples thereof include those described in JP-A Nos. 58-175693, 59-31194, 60-18387, 60-19586, 60-19587, 60-35054, 60-36190, 60-36191, 60-44554, 60-44555, 60-44389, 60-44390, 60-54892, 60-47069, 68-209995, and 4-25492, Japanese Patent Application Publication Nos. 1-38680 and 6-26028, German Patent. No. 350399, and the recitations on page 1141 of the October 1992 edition of the Chemical Society of Japan Bulletin.

The amount of the discoloration inhibitor such as the singlet oxygen quencher is usually in the range of 0.1 to 50% by weight, preferably in the range of 0.5 to 45% by weight, more preferably in the range of 3 to 40% by weight, and particularly preferably in the range of 5 to 25% by weight relative to the weight of the dye contained in the information recording layer.

Specific examples of the materials for forming a phase-transition recording layer include: Sb—Te alloy, Ge—Sb—Te alloy, Pd—Ge—Sb—Te alloy, Nb—Ge—Sb—Te alloy, Pd—Nb—Ge—Sb—Te alloy, Pt—Ge—Sb—Te alloy, Co—Ge—Sb—Te alloy, In—Sb—Te alloy, Ag—In—Sb—Te alloy, Ag—V—In—Sb—Te alloy, and Ag—Ge—In—Sb—Te alloy. Among them, Ge—Sb—Te and Ag—In—Sb—Te alloys are preferable, as the layers thereof are re-recordable a great number of times.

The thickness of the phase-transition recording layer is preferably in a range of 10 to 50 nm and more preferably in a range of 15 to 30 nm.

The phase-transition recording layer described above can be formed, for example, by gas-phase thin film deposition methods such as sputtering and vacuum deposition.

Image-Recording Layer

As previously described, the optical disk of the present invention has an image-recording layer (in the first embodiment) at the side of the protective substrate or the transparent layer side, and in the second and third embodiments, on the surface at the opposite side of the information recording layer. Visible images (i.e., visible information) selected by the user such as characters, graphics, pictures and the like are recorded on the image-recording layer. Examples of visible images include, for example, the title of the disc, content information, content thumbnails, related pictures, design pictures, copyright information, day and time of recording, recording method, recording format, barcodes and the like.

More specifically, the visible image to be recorded in the image-recording layer means an image which is visually recognizable, and examples thereof include all visually recognizable information such as any characters/letters (lines), pictures, and graphics. Examples of character/letter information include authorized user identification information, expiration date information, designated allowable number of times of use information, rental information, resolution-specifying information, layer-specifying information, user-specifying information, copyright holder information, copyright number information, manufacturer information, production date information, sales date information, dealer or seller information, usage set-number information, area identification information, language-specifying information, application-specifying information, product user information, and usage number information.

The only requirement of the image-recording layer is to be able to visibly record image information such as character, image, and picture by irradiation of laser light. The dyes described in the above explanation about the information recording layer can also be preferably used as the material for forming the image-recording layer.

In the optical disk according to the invention, the components for the information-recording layer (dye or phase-change recording material) and the components for the image-recording layer may be the same as each other or different from each other, but are preferably different from each other, because the required properties of the information-recording layer and the image-recording layer are different. Specifically, components superior in recording and reproduction characteristics are favorably used as the components for information-recording layer, while components effective in increasing the contrast of the recorded image are favorable as the components for image-recording layer. Examples of the dye that is used in the image recording layer and is preferable in view of improving contrast of the recorded image include cyanine dyes, phthalocyanine dyes, azo dyes, azo metal complex dyes, and oxonol dyes.

Leuco dyes may also be used. Favorable examples thereof include crystal violet lactone; phthalide compounds such as 3,3-bis(1-ethyl-2-methylindol-3-yl)phthalide and 3-(4-diethylamino-2-ethoxyphenyl)-3-(1-ethyl-2-methylindol-3-yl)-4-azaphthalide;

fluorane compounds such as 3-cyclohexylmethylamino-6-methyl-7-anilinofluorane, 2-(2-chloroanilino)-6-dibutylaminofluorane, 3-diethylamino-6-methyl-7-anilinofluorane, 3-diethylamino-6-methyl-7-xylidinofluorane, 2-(2-chloroanilino)-6-diethylaminofluorane, 2-anilino-3-methyl-6-(N-ethylisopentylamino)fluorane, 3-diethylamino-6-chloro-7-anilinofluorane, 3-benzylethylamino-6-methyl-7-anilinofluorane, or 3-methylpropylamino-6-methyl-7-anilinofluorane; and the like.

Either the recording layer or the image-recording layer can be a phase-transition layer the other can be a dye-containing layer. Preferable example thereof include the configuration in which the recording layer is a phase-transition layer and that the image-recording layer is a dye-containing layer.

The image-recording layer can be formed by preparing a coating liquid by dissolving a dye described above in a solvent and applying the coating liquid. Examples of the solvents include the solvents used in preparing the coating liquid for information recording layer. Other additives and application methods are the same as those described above for the information recording layer.

It is preferable that the pitch of the tracking grooves formed in the image-recording region of the image-recording layer in the first and second embodiments be made in the range of 0.3 to 200 μm from the standpoint of recording laser strength distribution, further preferable in the range of 0.6 to 100 μm and even more preferable in the range of 1.5 to 50 μm.

It is preferable that the layer thickness of the image-recording layer in the first embodiment be in the range of 0.01 to 50 μm, and further preferable in the range of 0.02 to 20 μm and even more preferable in the range of 0.03 to 5 μm. In the second embodiment, it is preferable to be in the range of 0.01 to 200 μm, further preferable in the range of 0.05 to 20 μm and even more preferable in the range of 0.1 to 5 μm.

In the optical disk of the first embodiment of the present invention, tracking grooves can be provided on the protective substrate corresponding to the image-recording region at the side of the image-recording layer. When the image-recording layer is formed adjacent to the protective substrate, grooves can be provided with ease in the image-recording region by providing grooves on the protective substrate. Then, by performing image recording in a state where the formed grooves are tracked by laser pickup, the pickup positioning can be accurately controlled so precise images can be recorded. Also, by providing the grooves in the image-recording layer, an effect can be obtained where a pretty rainbow color can be seen on the surface due to interference of light.

When providing grooves, it is preferable that the shape thereof be in a spiral form or in the form of concentric circles since tracking is performed in a state where the optical disk is in rotation. The shape of these grooves can be made different from the groove shape of the information recording layer. The pitch of the grooves in the image-recording layer and the groove pitch of the recording layer can also be made to be different. Specifically, the pitch of the grooves in the image-recording layer can be made wider than the grooves in the information recording layer. The reason for this is that the objective behind the pitch of the grooves in the image-recording layer is tracking during image recording. Accordingly, as long as a visible image can be recorded with precision, it is not necessary for the pitch of the image-recording layer grooves to be made as narrow as the pitch of the grooves (i.e., the track pitch) in the information recording layer the pitch thereof is set in order to raise the recording density.

From the standpoint of strength distribution of the recording laser, it is preferable that the pitch of the tracking grooves formed in the image-recording region of the image-recording layer in the first embodiment be in the range of 0.3 to 200 μm, further preferable in the range of 0.6 to 100 μm, and even further preferable in the range of 1.5 to 50 μm.

Also, it is preferable that tracking be performed when recording an image, and that the groove depth, when the substrate thickness at the side from which the laser incidences is 0.6 mm, be in the range of 50 to 200 nm. It is further preferable that the depth be in the range of 80 to 150 nm and even further preferable to be made in the range of 100 to 130 nm. It is preferable that the width of the grooves be in the range of 10 to 600 nm, further preferable in the range of 200 to 500 nm and even further preferable in the range of 250 to 450 nm. It should be noted that the optimum ranges for factors such as the shapes of the grooves, laser wavelength, NA, substrate thickness and the like differ.

When a configuration of the optical disk is like the one in FIG. 1, examples of the method for forming the grooves on the image-recording layer include a utilization of the grooves in the protective substrate formed by injection molding.

Further, when a configuration of the optical disk is like the one in FIGS. 2 and 3, examples of the method for forming the grooves on the image-recording layer include a utilization of the grooves on the information recording layer side of the substrate. In this case, the information recording layer is formed by coating, whereby the grooves of the information recording layer may become shallower than the grooves on the information recording layer side of the substrate due to leveling, while it is possible to maintain a certain amount of depth.

In the third embodiment of the present invention, in order to form the desired visible image easily in the image-recording layer (380a and 380b in FIG. 5) and to excel the visibility qualities of the formed visible image, the conditions to be fulfilled differ as follows in accordance with the configuration of the optical disk.

In the case of the first optical disk in the third embodiment of the present invention, tracking grooves used for recording an image are provided on the second substrate 390a, as was discussed above. In order to meet the mode of this second substrate 390a, it is necessary for the image-recording layer 380a to fulfill all of the following conditions (1) through (6):
(1) the refraction rate thereof for the laser light having a wavelength of 660 nm is in a range of 1.7 to 2.5;
(2) the extinction coefficient thereof for the laser light having a wavelength of 660 nm is in a range of 0.03 to 0.20;
(3) the temperature where decomposition thereof starts is in a range of 150 to 350° C.;
(4) the thickness of a land portion thereof is in a range of 10 and 200 nm;
(5) the thickness of the groove portion is in a range of 50 to 300 nm; and
(6) the thickness of the groove portion is greater than that of the land portion.

Further, in the case of the second optical disk in the third embodiment of the present invention, the second substrate 390b is smooth and no grooves are provided thereon, as described above. In order to meet the mode of this second substrate 390b, it is necessary for the image-recording layer 380b to fulfill all of the above conditions (1) to (3) and the following (7):
(7) The thickness thereof is in a range of 30 to 300 nm, and the thickness of the image recording layer in the image-recording area is in a range of ±30% with respect to an average value of the thickness of the image recording layer.

These conditions will be explained in detail.

For the image-recording layer 380a, the land portions have a thickness of 10 to 200 nm, and the groove portions have a thickness of 50 to 300 nm, and, in addition, it is necessary to fulfill the relationship where “Thickness of groove portions>Thickness of land portions”.

Further, it is preferable that the thickness of the land portions range from 12 to 100 nm, and the thickness of the group portion ranges from 70 to 200 nm, and also that the relationship of “(Thickness of groove portions)−(Thickness of land portions)>20 nm” is met. It is more preferable that the thickness of the land portions range from 15 to 50 nm, and the thickness of the groove portions range from 100 to 170 nm, and also that the relation of “(Thickness of groove portions)−(Thickness of land portions)>50 nm” is met.

When the thickness of the image-recording layer 380a is less than 10 nm at the land portions and less than 50 nm at the groove portions, a problem occurs in that sufficient visibility cannot be obtained; and when it exceeds 200 nm at the land portions and exceeds 300 nm at the groove portions, a problem occurs in that sufficient visibility and sensitivity cannot be obtained.

Further, when a relation where “(Thickness of groove portions)<(Thickness of land portions)” is reached, a problem occurs in that film formation with an ordinary spin coat method becomes difficult.

On the other hand, it is necessary that the thickness of the image-recording layer 380b range between 30 to 300 nm, and that the thickness of the image-recording layer within the image-recording area be within ±30% of the average value of the thickness of the image-recording layer. Also, it is preferable that the thickness of the image-recording layer 380b range from 50 to 250 nm, and that the thickness of the image-recording layer within the image-recording area be within ±20% of the average value of the thickness of the image-recording layer. It is further preferable that the thickness range from 100 to 200 nm, and that the thickness of the image-recording layer within the image-recording area be within ±10% of the average value of the thickness of the image-recording layer.

When the thickness of the image-recording layer 380b is less than 30 nm, a problem occurs in that sufficient visibility cannot be obtained; and when it exceeds 300 nm, a problem occurs in that sufficient visibility and sensitivity cannot be obtained. When the thickness of the image-recording area of the image-recording layer 380b exceeds an average value of ±30% of the thickness of the image-recording layer, a problem occurs in that the image quality in the image-recording area becomes uneven.

It is necessary that the refractive index at a wavelength of 660 nm for the image-recording layers 380a and 380b be in the range of 1.7 and 2.5, preferably in the range of 1.9 and 2.5 and further preferably in the range of 2.2 and 2.5.

When the above-described refractive index is less than 1.7, a problem occurs in that sufficient contrast cannot be obtained, and when it exceeds 2.5, a problem occurs in that it is an obstacle to the dissolution qualities of solvents suitable for use in spin coating methods.

Here, the disclosure of “refractive index at a wavelength of 660 nm” refers to the refractive index relative to light having a wavelength of 660 nm. This refractive index can be measured with an ellipsometer.

It is necessary for the extinction coefficient at a wavelength of 660 nm of the image-recording layers 380a and 380b to be in the range between 0.03 and 0.20. It is preferable that it be in the range between 0.05 and 0.15, and further preferable that it be in the range between 0.07 and 0.13.

When the above-described extinction coefficient is less than 0.03 or over 0.20, a problem occurs in that sufficient sensitivity and visibility cannot be obtained.

Hereafter, the extinction coefficient will be explained.

Here, the extinction coefficient k of a dye is the absolute value of an imaginary number of the complex refractive index of the image-recording layer relative to the wavelength of the laser being used in image recording, and is a value that becomes an indicator of the light absorption ratio. In the present invention, the value was found in accordance with the following method from the measured values of the transmittance and reflectivity of the image-recording layer relative to the laser wavelength.

The extinction coefficient k is generally expressed by the following Equation (1) using an absorption coefficient α.
k=α_{d}λ/4π Equation (1):

In Equation (1), λ is the wavelength of the recording laser.

The optic density α_{d} that is the product of the absorption coefficient α and the film thickness d of the image-recording layer can be found with the following Equation (2) using: a transmittance T₀ and reflectivity R₀ relative to the incident light actually measured from the image-recording layer side; the reflectivity R₀′ relative to the incident light from the surface on the opposite side from where the image-recording layer was formed; and a reflectivity R_{S} at the substrate only.
α_{d}=ln(1/T₀)+ln(1−R₀)+ln(1−R₀′+1/2 R_{S}) Equation (2):

Accordingly, the extinction coefficient k of the image-recording layer relative to the recording laser wavelength can be found with the following Equation (3) where Equation (2) has been substituted for Equation (1).
k=λ[ln(1/T₀)+ln(1−R₀)+ln(1−R₀′+1/2 R_{S})]/4πd Equation (3):

It should be noted that the reflectivity R_{S} at only the substrate is the refractive index in the optical disk at the portions where the image-recording layer is not provided.

The extinction coefficient of the image-recording layers 380a and 380b can also be found using methods besides the above Equation (3). This can be found using a spectroscopic ellipsometer that uses probe light made to be monochromatic, with the desired wavelength, from a white light source with a monochrometer.

It is necessary for the temperature at which dissolution for the image-recording layers 380a and 380b begins to range between 150 and 350° C., preferably in the range of 170 to 300° C., and further preferably in the range of 190 and 250° C.

When the temperature at which dissolution begins is less than 150° C., a problem occurs in that the storage stability is inferior, and when it exceeds 350° C., a problem occurs with the sensitivity of the image recording.

In the present invention, the temperature at which dissolution begins can be found by measuring the dye powder used in the image-recording layers 380a and 380b with a TG-DTA device.

With the optical disks 100a and 100b of the third embodiment of the present invention, the recording substance of the already explained information recording layer 20 (i.e., the dye or the phase change recording material) and the recording substance of the image-recording layers 380a and 380b can be made either the same or different, however, since the qualities demanded of each of the information recording layer 320 and the image-recording layers 380a and 380b are different, it is preferable that the recording substances differ. More specifically, it is preferable that the information recording layer 320 comprise a recording substance that excels in recording and playback qualities, and that the image-recording layers 380a and 380b comprise a dye that is a recording substance that raises the contrast of a recorded visible image.

The image-recording layers 380a and 380b can be layers that include dye and the information recording layer 320 can function as a phase change-type or recording-type layer.

The dye included in the image-recording layers 380a and 380b is not limited, as long as it can improve the contrast of the recorded visible image and can fulfill conditions matching each of the above-described embodiments when forming an image-recording layer. Specific examples of favorable dyes include, from among the dyes cataloged as recording substances for the information recording layer 320, cyanine dyes, phthalocyanine dyes, azo dyes, azo metallic complex dyes and oxonol dyes. Especially preferable examples include trimethine cyanine dyes, pentamethine cyanine dyes, monomeric oxonol dyes and dimeric-type oxonol dyes.

These dyes can be used individually or multiple dyes can be mixed appropriately and used.

Further, in order to make both the image-recording layers 380a and 380b satisfy the above-described conditions, it is preferable either not to add optional components besides the dye that makes up the layer, e.g., binders and discoloration inhibitors and the like, or to keep the amount of additives to the very minimum necessary.

The image-recording layers 380a and 380b can be formed by preparing a coating liquid by dissolving a dye described above in a solvent and applying the coating liquid. Examples of the solvents include the solvents used in preparing the coating liquid for information recording layer 20. Other additives and application methods are similar to those described above for the information recording layer.

As with the optical disk 100a shown in FIG. 5A, when protrusions and depressions are formed in a shape to follow the form of the second substrate 390a on the surface where the light incidences for the image-recording layer 380a, image recording can be performed by using those protrusions and depressions in a state where they are tracked. Also, by providing the protrusions and depressions in the image-recording layer, an effect can be obtained where attractive iridescence can be seen on the surface due to interference of light.

Substrate

The substrate used in the optical recording medium of the invention may be selected from various materials hitherto used as the substrates for conventional optical recording media.

Examples of substrate materials include glass, acrylic resins such as polycarbonate or polymethyl methacrylate, polyvinyl chlorides such as polyvinyl chloride or vinyl chloride copolymers, epoxy resins, amorphous polyolefins and polyesters, and these resins may be used in combination if desired.

These materials may be used in the film shape or the rigid plate shape. Among the materials above, polycarbonate is preferable in view of humidity resistance, dimensional stability, and cost.

An undercoating layer can be provided at the substrate surface on the side where the information recording layer is provided (i.e., the surface whereon the groove is formed) for improving the planarity and adhesiveness, and preventing deterioration of the recording layer.

Examples of materials for forming the undercoat layer include polymer materials such as polymethyl methacrylate, acrylic acid-methacrylic acid copolymers, styrene-maleic anhydride copolymers, polyvinyl alcohol, N-methylol acrylamide, styrene-vinyl toluene copolymers, chlorosulfonated polyethylene, nitrocellulose, polyvinylchloride, chlorinated polyolefin, polyester, polyimide, vinyl acetate-vinyl chloride copolymers, ethylene-vinyl acetate copolymers, polyethylene, polypropylene, or polycarbonate; and surface modification agents such as silane coupling agents. The undercoat layer can be prepared by preparing a coating liquid by dissolving or dispersing the materials in a suitable solvent, and applying the coating liquid onto a substrate surface by, for example, a suitable application method such as spin coating, dip coating, or extrusion coating.

The thickness of the undercoat layer is generally in the range of 0.005 to 20 μm and preferably in the range of 0.01 to 10 μm.

In the first embodiment of the present invention, it is preferable that the thickness of the substrate be in the range of 0.05 to 1.2 mm and more preferably in the range of 0.1 to 1.1 mm.

In the first embodiment of the present invention, protrusions and depressions (i.e., pre-grooves) representing tracking guide grooves or the information of address signals and the like are formed on the substrate.

In the case of DVD-R or DVD-RW, it is preferable that the track pitch of the pre-grooves is in the range between 300 to 900 nm, more preferably between 350 to 850 nm and further preferably between 400 to 800 nm.

The depth of pre-grooves (i.e., the groove depth) preferably ranges between 100 to 160 nm, more preferably between 120 to 150 nm and further preferably between 130 to 140 nm. Further, the groove width (i.e., half-value width) of the pre-grooves preferably ranges between 200 to 400 nm, more preferably between 230 to 380 nm and further preferably between 250 to 350 nm.

Meanwhile, a substrate with grooves having a narrower track pitch compared to conventional DVD-Rs and the like can be used in order to achieve even higher recording density. In this case, it is preferable that the track pitch of the grooves be in the range from 280 to 450 μm, more preferably in the range from 300 to 420 nm and further preferably in the range from 320 to 400 nm. Further, it is preferable that the depth of the grooves (groove depth) is in the range between 15 to 150 nm and further preferable in the range between 25 and 100 nm. Further, it is preferable that the groove width of the grooves is in the range between 50 and 250 nm and further preferably to be in the range between 100 and 200 nm.

In the second embodiment of the present invention, the thicknesses of the first and second substrates are preferably in a range of 0.1 to 1.2 mm and more preferably in a range of 0.2 to 1.1 mm. It is basically preferable that a groove or a servo signal for tracking is formed on the first substrate. Further, a substrate having such a groove or a servo signal for tracking formed thereon may be used as the second substrate. The track pitch of the groove of the first substrate is preferably in the range of 280 to 450 nm and more preferably in the range of 300 to 420 nm. The depth of groove (groove depth) is preferably in the range of 15 to 150 nm and more preferably in the range of 25 to 100 nm.

The groove for tracking may be further formed on the second substrate in order to record an image having high accuracy. In such a case, a track pitch of the groove is preferably in a range of 0.3 to 200 μm, more preferably in a range of 0.6 to 100 μm, and still more preferably in a range of 1.5 to 50 μm in view of the distribution of intensity of recording laser.

When tracking is performed during image recording and a thickness of the substrate on the side from which laser light incidents is 0.6 mm, a depth of the groove is preferably in a range of 50 to 200 nm, more preferably in a range of 80 to 150 nm, and still more preferably in a range of 100 to 130 nm. A width of the groove is preferably in a range of 100 to 600 nm, more preferably in a range of 200 to 500 nm, and still more preferably in a range of 250 to 450 nm. The most preferable range of a shape of the groove may vary depending on a wavelength of laser light, NA, a thickness of the substrate and the like.

In the third embodiment of the present invention, the thickness of the first substrate (310 in FIG. 5) is preferably in the range of 0.1 to 1.2 mm, and more preferably in the range of 0.55 to 0.65 mm.

Tracking grooves used for recording information are also formed in the first substrate 310.

It is preferable that the track pitch of the grooves formed on, the first substrate 310 are in the range between 300 and 1600 nm, more preferably 320 and 750 nm, and further preferably between 400 and 740 nm.

Further, it is preferable that the depth of the grooves (groove depth) are in the range, in the case of a DVD-R or DVD+R, between 80 and 200 nm, more preferably between 100 and 180 nm, and further preferably are in the range between 110 and 160 nm.

Furthermore, in the case of a DVD-R or DVD+R, it is preferable that the half value width of the grooves range between 200 and 400 nm, more preferably to range between 230 and 380 nm, and further preferably to range between 250 and 350 nm.

In the third embodiment of the present invention, a material the same as the material used for the first substrate 310 can be used for the second substrate (i.e., 390a and 390b in FIG. 5).

It is preferable that the thickness for both the second substrates 390a and 390b to be between 0.1 and 1.2 mm and further preferably between 0.55 and 0.65 mm.

With the first optical disk in the third embodiment of the present invention, tracking grooves used with the recording of an image are formed on the second substrate 390a, as shown in FIG. 5A.

It is preferable that the track pitch of the grooves formed on the second substrate 390a be in the range between 0.3 and 200 μm, more preferably between 0.6 and 100 μm, and further preferably be in the range between 1.5 and 50 μm.

It is also preferable that the depth of the grooves (groove depth) are in the range between 50 and 200 nm, more preferably in the range between 80 and 150 nm, and further preferably in the range between 100 and 300 nm.

Further, it is preferable that the groove width is in the range between 100 and 600 nm, more preferably 200 and 500 nm, and further preferably in the range between 250 and 550 nm.

With the second optical disk in the third embodiment of the present invention, the average height (Rc) of the protrusions and depressions on the second substrate 390b must be 10 nm or less. Here, the average height (Rc) of the protrusions and depressions are expressed with the following equation. That is, when the deviation from the average line of the peak and valley bottom is made Yp and Yv, the sum of the average of all of the Yp added to the average of all of the Yv becomes the average height (Rc) of the protrusions and depressions.

$$Rc = \frac{1}{n} {\sum }_{i = 1}^{n} Ypi + \frac{1}{n} {\sum }_{i = 1}^{n} Yvi$$

The average height (Rc) of the protrusions and depressions of the second substrate 390b is 10 nm or less meaning that the surface of the second substrate 390b is smooth, i.e., this shows that grooves such as found on the above-described second substrate 390a are not formed on the second substrate 390b.

It should be noted that in the present invention, the average height (Rc) of the protrusions and depressions can be measured with a method as specified in ISO4287/1.

The undercoating layer described above can be provided on the surface at the side where the image-recording layer is provided in these types of second substrates 390a and 390b as well, as with the first substrate 310.

It should be noted that when the optical disk of the present invention is a playback-only type disc, a information-recording section in which information is recorded that can be played back with a laser is provided on the substrate as pits. Also, in this case, an information recording layer is not formed.

Reflection layer

A reflection layer is provided adjacent to the information recording layer or the image-recording layer for improvement of reflectance during reproduction of information. The light-reflecting material used for the reflection layer is a material having a high reflectance for laser beam, and examples thereof include metals and semimetals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, and Bi, and stainless steel. These materials may be used alone, in combinations of two or more, or as alloys. Preferable examples among these include Cr, Ni, Pt, Cu, Ag, Au, Al and stainless steel. More preferable examples among these include Au metals, Ag metals, Al metals and alloys made from these, and most examples among these include Ag metals, Al metals and alloys made from these. The reflection layer can be formed on the substrate or the information recording layer by vapor deposition, sputtering or ion plating of the light-reflecting material. The thickness of the reflection layer is generally in the range of 10 to 300 nm, preferably in the range of 50 to 200 nm.

In light of the fact that the protective layer and adhesive layer are made to harden with ultraviolet rays, it is preferable that the reflection layer exhibit a transmittance of 10% or more for a laser having a wavelength of 390 nm or less (especially for a laser with a wavelength of 365 nm). Further, in light of the fact that images are recorded with lasers having wavelengths of 405 nm, 660 nm or 780 nm, it is preferable that the transmittance be 70% or less especially relative to lasers with the above wavelengths.

In the optical disk in the third embodiment of the present invention, a first reflection layer (330 in FIG. 5) is provided in order to improve the reflectivity during the playback of information, and a second reflection layer (370 in FIG. 5) is provided in order to improve the visibility of the visible image.

It is necessary for the thicknesses of the first reflection layer (330 in FIG. 5) and the second reflection layer (370 in FIG. 5) to both be in the range from 15 to 200 nm. It is preferable that they be in the range from 20 to 150 nm and more preferable to be in the range between 80 and 130 nm. When the thickness of the reflection layer 30 is thin, especially under 10 nm, a problem occurs in that normal recording and playback of information cannot be performed, and when it exceeds 200 nm, issues with cost arise. Also, when the thickness of the second reflection layer 70 is under 15 nm, a problem occurs in that sufficient visibility cannot be achieved and when it exceeds 200 nm, issues with cost arise.

Semi-Transparent Reflection layer

At least one of the reflection layer in the optical disk of the first embodiment of the present invention, and the reflection layer in the first lamination body of the optical disk of the second embodiment of the present invention, and the reflection layer in the second lamination body is a semi-transparent reflection layer. Here, reference to “semi-transparent” means that only a fixed amount of light, relative to the light of the same wavelength as the laser used for information recording and image recording, passes through, and that almost all of the remaining light is reflected. The semi-transparent reflection layer's transmittance relative to radiation rays is 10% or more, preferably 20% or more, further preferably between 30 and 70%, even more preferably between 40 and 60%, and most preferably between 55 and 65%. The transmittance can be easily found on a substrate on which a information recording layer is not formed. A film of the reflection layer is formed and this is measured with a spectrophotometer. In the actual optical disk, the desired transmittance can be obtained by providing a semi-transparent reflection layer after forming the information recording layer, with the condition that the thickness of the reflection layer is formed at between several nm to several tens of μm. The reflectivity coupled with the image-recording layer is 10% or more relative to the laser used for image recording. It should be noted that this transmittance is the transmittance for the semi-transparent reflection layer on its own and is a value that excludes absorption due to the image-recording layer.

Further, the above-described light reflective substance can be used in the semi-transparent reflection layer, however, if it is the semi-transparent reflection layer with the above-described transmittance and reflectivity, the most suitable layer thickness of the reflection layer should be selected in accordance with the optic qualities of the material used for the layer. For example, in the case of an alloy whose main element is silver, it is preferable to make the thickness 5 to 70 nm, more preferable 10 to 50 nm and further preferable to be 20 to 40 nm.

Adhesive Layer

In the optical disk of the first embodiment of the present invention, when making an optical disk that is a type that is stuck together such as a DVD and the like, an adhesive layer is provided to adhere two layered bodies or adhere the lamination body and protective substrate. With the optical disk of the second and third embodiments of the present invention, there is an adhesive layer for adhering the first lamination body and the second lamination body.

For the material that forms the adhesive layer in the first embodiment and second embodiment of the present invention, it is preferable to use an adhesive hardened with radiation rays and, in order to prevent warping of the disc, an adhesive with a small rate of shrinkage with hardening is preferable. Also, since a semi-transparent reflection layer having a transmittance that is at least of a certain amount or above to radiation rays is used in the first lamination body and/or second lamination body in the second embodiment of the present invention, a radical polymerizable radiation cured adhesive that has an immediate effect can be used. The radiation-curable adhesive is a resin that hardens by irradiation with electromagnetic waves such as ultraviolet, electron beam, X ray, y ray, or infrared, of these ultraviolet and electron beams are preferable. Examples of the radical polymerizable ultraviolet-curable resins among the radiation-curable resins include SD640 and SD661 manufactured by Dainippon Ink and Chemicals, Inc., and SK6100, SK6300, and SK6400 manufactured by Sony Chemicals Corp. (all trade names). Further, in order to endow the adhesive layer with elasticity, it is preferable that, in the first and second embodiments of the present invention, the thickness of the adhesive layer is in the range of 1 to 100 μm, more preferably range in the range of 5 to 60 μm, and particularly preferably in the range of 20 to 55 μm.

When adhering is performed by using a ultraviolet-curable resin, ultraviolet rays can be irradiated not only from the side having the semi-transparent reflection layer but also from the opposite side. This is due to the fact that there are cases where ultraviolet rays transmit from the reflection layer, albeit only slightly, and there is an effect where the temperature difference between both surfaces is alleviated and it thus becomes harder for warping to occur.

In the third embodiment of the present invention, examples of materials that can be used to constitute the adhesive layer include a ultraviolet-curable resin used to form the protective layer, which will be described later, and a synthetic resin. Examples of synthetic resins include a slow curing adhesive such as a cation hardening-type epoxy resin and a spin hardening-type adhesive such as a UV-curing acrylate resin. Of these, it is preferable to use a slow curing adhesive. This is due to the fact that a coating film of a slow curing adhesive can be formed in advance on the sticking surface of at least one of the first lamination body and second lamination body, and this surface can be stuck after irradiating the coating film with ultraviolet rays. Due to this, the sticking together of the discs can be performed with high precision. Examples of slow curing adhesives include the cation hardening-type epoxy resins and the like. Specifically, SK7000 (trade name) manufactured by Sony Chemical Corp. and the like can be used. These adhesives are coated onto at least one of the sticking surfaces with a method such as roll coating, spin coating, screen printing and the like. The adhesive layer is then formed by hardening the adhesive.

Protective Substrate

In the first embodiment of the present invention, the protective substrate (i.e., the dummy substrate) is provided on the surface on the opposite side of the substrate when comprising optical disks that are the stick together-type. The same substance used for the above-described substrate can be used as the material. Also, as with the above-described substrate, the same kind of substrate and grooves can be provided on the surface at the side where the image-forming layer was formed, or the grooves can be excluded. It is preferable that the thickness of the protective substrate be 0.05 to 1.2 mm, more preferably 0.1 to 1.1 mm and further preferable 0.5 to 0.7 mm.

Protective Layer

A protective layer is provided in order to physically and chemically protect the reflection layer, information recording layer, image-recording layer and the like. When using a slow curing adhesive in the adhesion of the first lamination body and second lamination body, bubbles tend to enter the coating of the slow curing adhesive during the widely used screen printing process, especially with the optical disk of the third embodiment of the present invention. This affects the recording and playback of information so it is preferable that a first protective layer (340 in FIG. 5) and a second protective layer (360 in FIG. 5) be provided.

Examples of materials that can be used for the protective layer include organic substances such as thermally plasticizing resins, thermally hardening resins, UV hardening resins as well as inorganic substances such as ZnS, ZnS—SiO₂, SiO, SiO₂, MgF₂, SnO₂ and Si₃N₄. The protective layer can be provided by methods such as vacuum deposition, sputtering, coating and the like.

Also, in the vase of a thermoplastic resins or thermocuring resins, the layer can also be formed by dissolving these in a suitable solvent and after preparing a coating fluid, the coating fluid is coated and dried. In the case of the UV hardening resin, the layer can also be formed by coating this coating liquid, irradiating UV light thereon and thus hardening it. All types of additives can be added into these coating liquids in accordance with the purpose, including additives such as antistatic agents, antioxidization agents and UV absorption agents. The layer thickness of the protective layer is usually in the range of 0.1 μm to 1 mm.

In particular in the first embodiment of the present invention, by further providing a transparent intermediate layer to act as a protective layer between the adhesive layer and the image-recording layer, as shown in FIG. 1, direct contact between the adhesive layer and the image-recording layer and subsequent deterioration of the image-recording layer can be prevented. Also, when the image-recording layer is a layer including a dye, the adhesive layer can be coated and dissolution of the image-recording layer (i.e., of the dye layer) can be prevented. It is preferable that the layer thickness for this protective layer range between 10 nm and 5 μm.

Image-Recording Method

Image recording to the image-recording layer of the optical disk of the present invention is performed with the optical disk of the present invention and a recording device that can at least record image information to the image-recording layer of the optical disk.

Hereafter, the recording device used in recording to the optical disk of the present invention will first be explained.

With the optical disk of the present invention, recording of an image to the image-recording layer and recording of optical information to the information recording layer can be performed by, e.g., one optical disk drive (i.e., recording device) with the recording capability to record to both layers. When using this kind in a single optical disk drive, recording is performed to one layer of either the image-recording layer or the information recording layer, after which the disc is flipped and recording is performed on the other layer. Optical disk drives that have the capability to record visible images to the image-recording layer are disclosed in JP-A Nos. 2003-203348, 2003-242750 or the like.

The recording device has at least a laser pickup that emits a laser and a rotation mechanism that rotates the optical disk. Recording and playback to the code recording layer is performed by irradiating a laser from the laser pickup toward the code recording layer of the optical disk in a state where it is being made to rotate. The configuration of such a recording device is well-known.

Further, when recording a visible image to the image-recording layer, the recording device makes the optical disk and the laser pickup move relative to each other along the surface of the optical disk. At the same time as this relative motion, the laser is adjusted in accordance with image information such as text characters, pictures and the like and irradiated towards the visible image recording layer, whereby a visible image is recorded. This type of configuration has been disclosed in, for example, JP-A No. 2002-203321.

Next, recording of information (digital data) to the information recording layer will be explained. When the information recording layer is dye-type layer, first, an unrecorded optical disk as described above is irradiated with a laser from the laser pickup while being rotated at a preset recording line speed. With this irradiation of light, the dye of the information recording layer absorbs the light, the temperature rises locally, and information is recorded by the desired pits being generated and the optical characteristics changing.

When forming one pit, the recording waveform of the laser can be a row of pulses or just a single pulse. The ratio relative to the length (i.e., pit length) that is to be recorded is important.

It is preferable that the pulse width of the laser is in the range between 20 and 95% relative to the length to be actually recorded, further preferable that it is in the range between 30 and 90% and even further preferable between 35 and 85%. Here, when the recording waveform is a pulse row, the meaning is that the sum of the pulses in the row are within the above-described ranges.

The power of the laser differs depending on the recording line speed. When the recording line speed is 3.5 m/s, it is preferable that it in the range between 1 and 100 mW, more preferable to be in the range between 3 and 50 mW and even more preferable to be in the range between 5 and 20 mW. Also, in a case where the recording line speed is doubled, the preferable range of laser power is 2^{1/2} times that of each of the ranges.

Also, in order to raise the recording density, it is preferable that the NA of the objective lens used in the pickup be 0.55 or greater, and more preferable 0.60 or greater.

An example of a lasers that can be used in recording to the optical disk of the present invention includes a semiconductor laser having an oscillation wavelength for the recording light within the rang between 350 and 850 nm.

A case where the information recording layer is a phase change-type will be explained. In the case of a phase change-type, the layer can be formed from the above-described substance and phase change can be cycled between a crystal phase and non-crystalline phase with the irradiation of a laser.

When recording information, a focused laser pulse is irradiated for a short period of time and portions of the phase change recording layer are melted. The melted portions cool quickly due to thermal diffusion, harden, and then recording marks of a non-crystalline state are formed. Also, when deleting, a laser is irradiated to the recorded mark portions and the marks are heated to a temperature at of above the crystallization temperature and up to the melting point of the information recording layer and by cooling removal is performed, whereby the non-crystalline recorded marks are crystallized and thus returned to the original non-recorded state.

Hereafter, the present invention will be explained in further detail with examples, however, the present invention is not limited to these examples.

### EXAMPLE 1

Making the Optical disk

Example 1 (i.e., the first embodiment of the present invention) is a DVD-R type optical disk made from two discs stuck together. The optical disk was made as follows.

First, a substrate was formed from a polycarbonate resin with injection molding so as to have a 0.6 mm thickness and a diameter of 120 mm and spiral grooves (depth: 130 nm, width 300 nm, track pitch: 0.74 μm). A coating liquid (1) was prepared by dissolving 1.5 g of the following Dye (1) in 100 ml of 2,2,3,3-tetrafluoro-1-propanol. This Coating liquid (1) was coated on the surface on which the above-described substrate grooves were formed with a spin coat method, whereby the information recording layer was formed.

A reflection layer 15 nm thick was formed on the information recording layer with a sputtering method using a target (APC) made from Ag: 98.1 mass, Pd: 0.9 mass and Cu: 1.0 mass. The inputted power was 2 kW and the Ar input flow was 5 sccm. The first disc was thus made with this process.

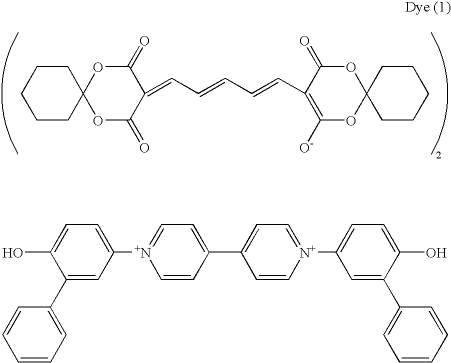

Next, in order to form the image-recording layer, 1.0 g of the above Dye (1) and 0.5 g of the below Dye (2) were dissolved in 100 ml of 2,2,3,3-tetrafluoro-1-propanol whereby a Coating liquid (2) was adjusted. This Coating liquid (2) was formed via spin coating on a substrate (i.e., the protective substrate) with a 0.6 mm thickness and a diameter of 120 mm and spiral tracking grooves (depth: 140 nm, width 300 nm, pitch: 0.74 μm). Next, a film was formed on the image-recording layer to act as a transparent protective layer. This was formed with RF sputtering while introducing argon gas so that layer of ZnO—Ga₂O₃ with a thickness of 15 nm was formed. The second disc was thus made with the above-described process.

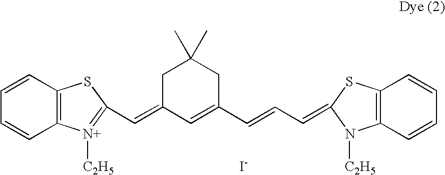

Next, in order that the first disc and second disc be stuck together and in order to complete one disc, the following steps were performed. A resin that hardens by ultraviolet rays (trade name: SD640, manufactured by Dainippon Ink and Chemicals, Inc.) was placed on the respective inner periphery regions of the semi-transparent reflection layer of the first disc and the transparent protective layer of the second disc and was coated with a spin coat method. Then, these were aligned on top of each other and made to an even film thickness while rotating them, and then bonded together with the irradiation of ultraviolet rays.

Evaluation

Contrast evaluation for image recording at a DVD-R recording and playback wavelength (660 nm) for the manufactured optical disk was performed as follows.

An image was recorded to the image-recording layer using a semiconductor laser with a 660 nm wavelength used for recording and playback of a DVD-R. The conditions were with a line speed of 3.5 m/s and a recording power of 18 mW, and this was performed in a state where the device was focused on the image-recording layer. In order to make the differences in contrast before and after recording into a numeric value, the reflectivity (550 nm wavelength) before and after recording was measured using a spectrophotometer (manufactured by Shimadzu Corporation).

As a result, it was seen that the difference in the reflectivity before and after image recording of the optical disk was 17%, and that the contrast between recorded portions and non-recorded portions was high. Further, this could be performed with no problem by focusing on the image-recording layer and controlling the tracking, either before or after the recording or playback of information to the information recording layer.

### EXAMPLE 2

The optical disk of Example 2 (i.e., the second embodiment of the present invention) was made as follows.

The first laminated body was made with the same process as with the first disc in Example 1 with the exception that the film formation of the reflection layer (first reflection layer) made 120 nm thick using a sputtering method.

Also, the second laminated body was made with the same process as the second disc in Example 1 except in that in place of the transparent protective layer, a semi-transparent reflection layer (second reflection layer) 30 nm thick was formed by sputtering an alloy having Ag—Nd 0.7 at %-Cu 0.9 at % (manufactured by Kobe Steel., Ltd.) on the image-recording layer (inputted power was 2 kW and the Ar input flow was 5 sccm).

Next, the first lamination body and the second lamination body were stuck together and in order to complete one disc, the following steps were performed. First, a radical polymerizable type ultraviolet curing resin (trade name: SK6400, manufactured by Sony Chemical Corp.) was coated with a spin coat method at low rotation speed on the inner periphery regions of the reflection layer of the first lamination body and the semi-transparent reflection layer of the second lamination body, in order to act as a radiation cured adhesive. Next, the first lamination body and the second lamination body were stuck together so that the side of the first reflection layer of the first lamination body faced the side of the semi-transparent reflection layer of the second lamination body. A metal halide lamp was used to irradiate ultraviolet rays from the side of the second lamination body while rotating the disc at high speed and the ultraviolet curing resin was hardened, whereby the first lamination body and second lamination body were stuck together and the disc of Example 2 was made.

### EXAMPLE 3

The optical disk of Example 3 (i.e., the second embodiment of the present invention) was made as follows.

The optical disk of Example 3 was made in the same way as in Example 2 except for the layer thickness of the first reflection layer of the first lamination body was 30 nm and this was made to be the semi-transparent reflection layer, the layer thickness of the second reflection layer of the second lamination body was made 120 nm, and the first lamination body and second lamination body were stuck together with the direction of irradiation for the ultraviolet rays from the side with the first lamination body.

### REFERENCE EXAMPLE

This reference example pertains to a DVD-R type optical disk where two discs are stuck together. Hereafter, the manufacturing method for this optical disk will be explained.

The first disc was made with the following process. Silver was sputtered onto the information recording layer on a substrate formed in the same manner as in Example 2, and after forming a reflection layer with a film thickness of 120 nm, an ultraviolet ray hardening resin (trade name: SD318, manufactured by Dainippon Ink and Chemicals, Inc.) was coated thereon with a spin coat method. Ultraviolet rays were irradiated and the resin hardened whereby a protective layer with a layer thickness of 10 μm was formed.

Next, silver was sputtered onto the image-recording layer formed in the same manner as in Example 2, and after forming a reflection layer with a film thickness of 120 nm, an ultraviolet ray hardening resin (the SD318 mentioned above) was coated thereon with a spin coat method. Ultraviolet rays were irradiated and the resin hardened, whereby a protective layer with a layer thickness of 10 μm was formed. The second disc was made with this process.

Next, the first disc and the second disc were stuck together, and the following steps were taken to complete one disc. First, a slow curing cation polymer-type adhesive (trade name: SDK7000, manufactured by Sony Chemical Corp.) was printed with screen printing on the protective layers of both discs. The mesh size of the screen printing board used at this time was 300 mesh. Next, a metal halide lamp was used and ultraviolet rays irradiated, immediately after which the first disc and the second disc were stuck together from their respective protective layer sides. The discs were pressed together from both sides and left for 5 minutes, whereby the optical disk of Reference Example 1 was made.

Evaluation

The following evaluations were made for the optical disk Examples 2 and 3 and Reference Example 1.

Evaluation of Image Visibility

Image Recording with a DVD-R Recording and Playback Wavelength (660 nm)

A semiconductor laser with a 660 nm wavelength used in recording and playback with DVD-R was used for the optical disks of Examples 1 to 2 and Reference Example 1. The conditions were such that at a line speed of 3.5 m/s, the recording power for the optical disk of Example 1 was 30 mW and the recording power for the optical disk of Example 2 was 15 mW, and recording to the image-recording layer was performed in a state where the device was focused. Next, functional evaluation of the recorded image was made by visual inspection and compared with the optical disk of Reference Example 1.

Evaluation of Recording Qualities

In order to record to the information recording layer with a laser wavelength of 660 nm at a line speed of 3.5 m/s, information recording was performed at a recording power of 15 mW for the optical disk of Example 1 and at a recording power of 30 mW for the optical disk of Example 2. Good recording and playback could be performed with a PI error of 50 or less (the standard is 280 or less).

It is seen from the above-described evaluation results that an image with high visibility could be formed with the optical disk of Example 2 in which a semi-transparent reflection layer was provided at the side of the image-forming layer, and that this image was not inferior even when compared to the image-recording layer of the optical disk of Reference Example 1 where a regular reflection layer was provided.

Further, it is similarly understood that information could be recorded with the optical disk of Example 3 in which a semi-transparent reflection layer was provided at the side of the information recording layer, and that this recording was not inferior even when compared to the information recording layer of the optical disk of Reference Example 1 where a regular reflection layer was provided.

### INDUSTRIAL APPLICABILITY

The optical disk of the present invention can record visible images with high contrast and good efficiency by using a laser. A radical polymerizable type radiation cured adhesive can be used in the adhesive layer and the disc can be manufactured at low cost. Further, the manufacturability of the disc is good and it excels in formation of visible images and the visibility thereof.

### EXPLANATION OF SYMBOLS

10 Substrate

20 Information recording layer

30 Reflection layer

40 Protective layer

50 Protective substrate

60 Image-recording layer

100 Optical disk of the first embodiment

210 Optical disk of the second embodiment

212 First substrate

214 Information recording layer

216 First reflection layer

220 First lamination body

222 Second substrate

224 Image-recording layer

226 Second reflection layer (semi-transparent reflection layer)

228 Second lamination body

230 Adhesive layer

310 First substrate

320 Information recording layer

330 First reflection layer

340 First protective layer

350 Adhesive layer

360 Second protective layer

370 Second reflection layer

380a, 80b Image-recording layers

390a, 90b Second substrates

100a, 100b Optical disks of the third embodiment

1. An optical disk comprising a substrate, one of an information recording layer or an information-recording portion, a reflection layer, and an image-recording layer, which are sequentially provided in this order, wherein:
a laser irradiated from the side of the substrate performs recording and playback of information;
an image is recordable in the image-recording layer by irradiation of a laser from the side of the substrate; and
the reflection layer is semi-transparent.

2. The optical disk of claim 1, wherein a transparent intermediate layer resides between the reflection layer and the image-recording layer.

3. The optical disk of claim 1, wherein the reflection layer has a transmittance of 10% or higher for a laser having a wavelength of 390 nm or less and a transmittance of 70% or less for a laser having a wavelength of 405 nm, 660 nm or 780 nm.

4. An optical disk comprising a first lamination body and a second lamination body which are adhered to each other, wherein:
the first lamination body comprises a first substrate, one of an information recording layer or an information-recording portion, and a first reflection layer which are sequentially provided in this order;
the second lamination body comprises a second substrate, an image-recording layer and a second reflection layer which are sequentially provided in this order;
the first lamination body and the second lamination body are adhered to each other so that the side of the first reflection layer and the side of the second reflection layer face each other via an adhesive layer;
the image-recording layer can record a visible image by irradiation of a laser light; and
at least one of the first reflection layer or the second reflection layer is a semi-transparent reflection layer.

5. The optical disk of claim 4, wherein an adhesive in the adhesive layer comprises a radical polymerizable radiation cured adhesive.

6. An optical disk comprising a first lamination body and a second lamination body which are adhered to each other, wherein:
the first lamination body comprises a first substrate, one of an information recording layer or an information-recording portion, and a first reflection layer which are sequentially provided in this order;
the second lamination body comprises a second substrate, an image-recording layer and a second reflection layer which are sequentially provided in this order;
the first lamination body and the second lamination body are adhered to each other so that the side of the first reflection layer and the side of the second reflection layer face each other via an adhesive layer;
the image-recording layer can record a visible image by irradiation of a laser light;
each of the thicknesses of the first reflection layer and the second reflection layer is within the range of 15 to 200 nm;
the image-recording layer comprises a dye;
the image-recording layer satisfies the following conditions (1) to (3); and
the image-recording layer satisfies the following conditions (4) to (6) or satisfies the following condition (7), wherein, in a case where the image-recording layer satisfies the following conditions (4) to (6), grooves are provided on the second substrate, and in a case where the image-recording layer satisfies the following condition (7), an average height of depression to protrusion (Rc) of the second substrate is 10 nm or less;
(1) the refraction rate thereof for the laser light having a wavelength of 660 nm is in a range of 1.7 to 2.5;
(2) the extinction coefficient thereof for the laser light having a wavelength of 660 nm is in a range of 0.03 to 0.2;
(3) the temperature where decomposition thereof starts is in a range of 150 to 350° C.;
(4) the thickness of a land portion thereof is in a range of 10 and 200 nm;
(5) the thickness of the groove portion is in a range of 50 to 300 nm;
(6) the thickness of the groove portion is greater than that of the land portion;
(7) the thickness thereof is in a range of 30 to 300 nm, and the thickness of the image recording layer in the image-recording area is in a range of ±30% with respect to an average value of the thickness of the image recording layer.

7. The optical disk of claim 6, wherein the conditions (1) to (6) are satisfied; and
the grooves are provided on each of the first substrate and the second substrate.

8. The optical disk of claim 6, wherein the disc satisfies the conditions (1) to (3) and (7).
